(19) United States
(12) Patent Application Publication
(10) Pub. No.: US 2017/0218665 A1
(43) Pub. Date: Aug. 3, 2017

(54) VEHICLE COMPUTER LOCK

(71) Applicants: Burton George Bergman, Brashear, TX (US); Judy Ann Bergman, Brashear, TX (US)

(72) Inventors: Burton George Bergman, Brashear, TX (US); Judy Ann Bergman, Brashear, TX (US)

(21) Appl. No.: 15/011,505

(22) Filed: Jan. 30, 2016

(51) Int. Cl. E05B 77/44; G06F 21/86

(52) U.S. Cl. CPC E05B 77/44; G06F 21/86

(57) ABSTRACT

A device and method for the protection of a computer used to regulate the performance of a vehicle is presented. The device is a two-piece unit configured to surround the computer. The device includes a base member and a lid member. The base member is configured to releasably couple to a wall of the engine compartment. The base member has a plurality of walls therein defining an internal volume for locating the computer. The lid member is in selective communication with the base member and is configured to cover an opening of the base member and one other surface. The lid member is secured to the base member.

### BACKGROUND

1. Field of the Invention

The present application relates to a locking device, and more particularly to a device used to secure vehicle computers within an engine compartment of a tractor trailer.

2. Description of Related Art

The trucking industry utilizes a thousands of trucks on the road at any one time. These trucks use advanced engine systems to haul loads throughout the country. The engine systems are not unique to a particular brand of truck. Multiple truck manufacturers will acquire and use the same type of engine system. Predominantly the truck manufacturers stick to a shared and single engine system. The engine system utilizes various computers mounted to the engine block in the engine compartment to regulate performance of the engine. These computers are located so as to be accessible underneath the trucks. Without these computers, the trucks become inoperable.

It has become more prevalent that individuals will steal these computers while a truck is parked. The cables are cut and the computer is pulled off the engine block as the mounting fasteners are removed. Currently, the process to steal a computer is only involving a matter of minutes. Loss of the computer places truck owners at a large disadvantage and financial stress. Computers cost thousands of dollars and are not readily available. Total financial losses accumulate from the initial purchase of the new computer and the resultant downtime waiting for it to be delivered and installed. The downtime can take weeks. Another issue is that insurance companies are experiencing increased claims for stolen computers which increases insurance rates for truck operators. No real steps have been taken to prevent theft of the computers used in the engine systems of tractor trailers. A locking device is needed.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a vehicle locking device according to the preferred embodiment of the present application.

FIG. 2 is a perspective exploded view of the vehicle locking device of FIG. 1.

FIG. 3 is a front view of a base unit in the vehicle locking device of FIG. 1.

FIG. 4 is a top view of the base member of FIG. 3.

FIG. 5 is a side view of the base member of FIG. 3.

FIG. 6 is a front view of a lid member in the vehicle locking device of FIG. 1.

FIG. 7 is a top view of the lid member of FIG. 6.

While the device and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The device and method in accordance with the present application overcomes one or more of the above-discussed problems commonly associated with the theft of computers from the engine compartment of tractor trailers. In particular, the device is configured to surround the computer in a hardened 2-piece unit to prevent access to the mounting fasteners for removal. The device is configured to selectively open so permit authorized access to selected individuals. The unit is lockable. These and other unique features of the device are discussed below and illustrated in the accompanying drawings.

The device and method will be understood, both as to its structure and operation, from the accompanying drawings, taken in conjunction with the accompanying description. Several embodiments of the device may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The device and method of the present application is illustrated in the associated drawings. The device includes a two-piece unit configured to surround an electronic computer used to regulate the performance of an engine. The unit includes a base member and a lid member. The base member mounts to a portion of the vehicle. The lid member releasably translates onto the base member in a secured fashion. A lock may be used to prevent unauthorized access. An advantage of the device of the present application is that the base member does not require any alteration to the mounting methods of the computer it is protecting. Additional features and functions of the device are illustrated and discussed below.

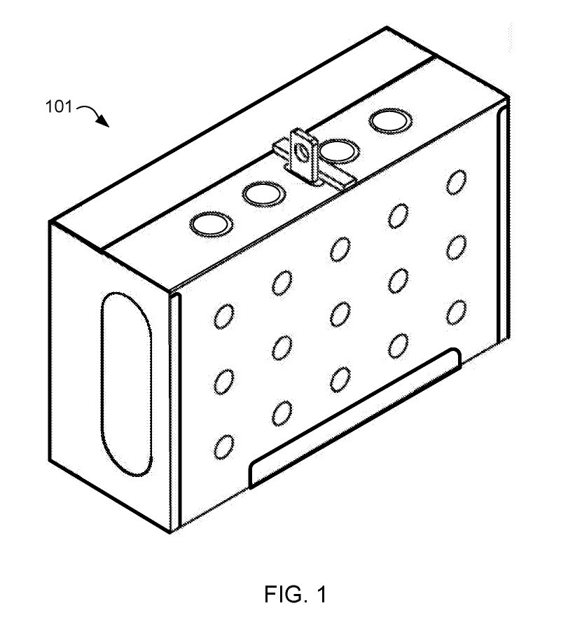

Referring now to the drawings wherein like reference characters identify corresponding or similar elements in form and function throughout the several views. FIG. 1 illustrates a perspective view of the vehicle locking device 101 of the present application. Device 101 is configured to prevent the unauthorized access and removal of a computer from an engine compartment of the vehicle. Additionally, device 101 is configured to operate with existing mounting fasteners used by the computers to avoid the need to retrofit existing computers or create specialized mounting devices. In use, device 101 prevents unauthorized access to the mounting fasteners of the computer, such that when secured, an individual is unable to remove the fasteners to take the computer.

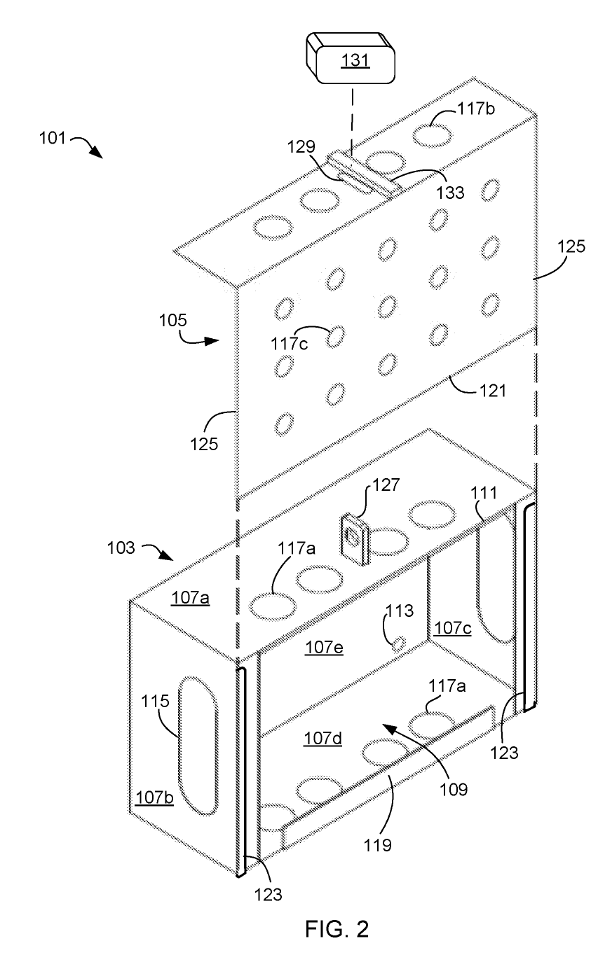

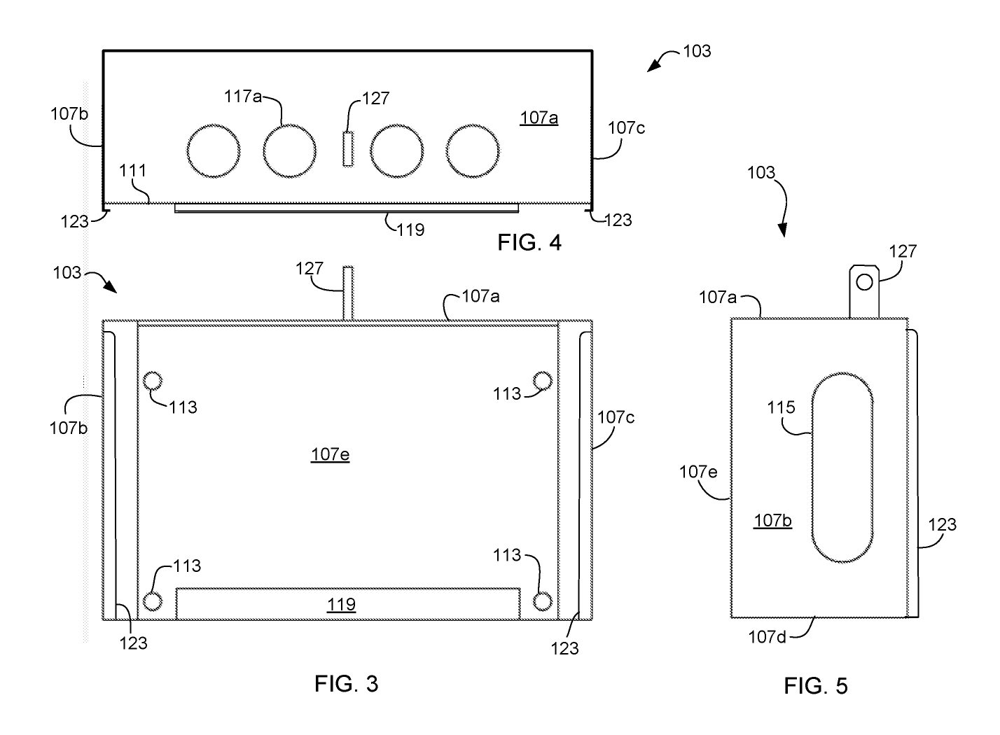

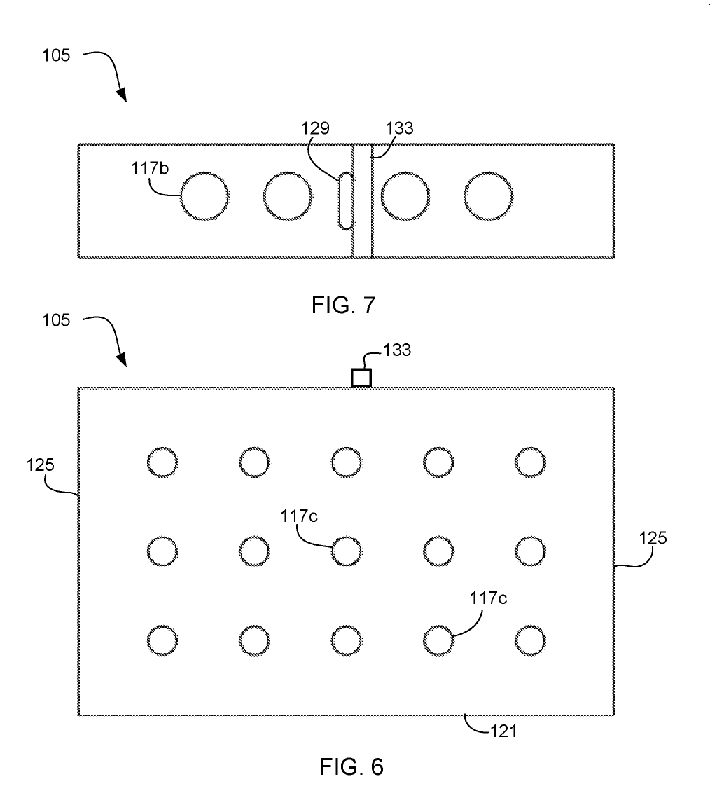

Device 101 is configured to include at least two members, namely a base member 103 and a lid member 105. Each member is shown in FIGS. 2-7 in greater detail. Base member 103 is configured to releasably couple to a wall of the engine compartment within the vehicle. The vehicle can be any of a truck, car, tractor trailer, personal or commercial vehicle. As seen in FIG. 2, an exploded perspective view of device 101 is shown. Base member 103 has a plurality of walls 107a -e defining an internal volume 109 for locating the computer. The computer (not shown for clarity purposes) is configured to pass through a front opening 111 for positioning within member 103. Lid member 105 is in selective communication with base member 103, such that lid member 105 covers at least two sides of base member 103. As illustrated, lid member 105 contacts and covers a portion of side/wall 107a and opening 111. Once secured, lid member 105 prevents access to the computer through opening 111.

As stated previously, device 101 is configured to operate with existing mounting fasteners used by the computer to avoid the need to retrofit existing computers or create specialized mounting devices. Computers are typically fastened at a number of locations directly to the engine block of the vehicle. Base member 103 is configured to have fastening apertures 113 along wall 107e that are aligned with the fastening pattern of the particular computer being protected. The fasteners for the computer pass through apertures 113 for engagement to the engine block as designed. In this configuration, base member 103 is located between the computer and the vehicle.

Base member 103 and lid member 105 further include a series of ports 115 and vent apertures 117. Side port 117 is configured to permit the passage of cables/wiring/conduit into and out of internal volume 109 such that the computer is in electrical and/or mechanical communication with the engine. Side port 117 also helps to act as a passage for the ventilation of heat from the computer.

Vent apertures 117 are associated with both base member 103 and lid member 105 and are primarily configured to permit airflow through internal volume 109 to regulate the temperature of the computer. Apertures 117 are located along any of walls 107 and surfaces of member 105. Vent apertures 117b and configured to align with vent apertures 117a in the upper wall 107a of member 103. It is desired that lid member 105 does not block off any of the vent apertures 117 associated with base member 103. Vent apertures 117c are located along the front face of lid member 105. It is understood that the quantity and size of apertures 117 and side ports 115 may be adjusted to accommodate particular needs of the computer and preferences of designers. They are not limited to illustrated embodiments herein.

Lid member 105 is secured in place to base member 103 along at least two areas. These areas are selected so as to prevent or greatly deter the ability to pry open lid member 105 away from base member 103. Base member 103 includes a lower lip 119 for acceptance of lid member 105. As lid member 105 is positioned relative to base member 103, member 105 is aligned within lower lip 119. Lip 119 extends out from opening 111. Lip 119 secures the edge 121 of lid member 105 relative to the base member 103. It is understood that the size and location of lower lip 119 is not herein limited to that described and illustrated. Lower lip may be adjusted according to various design parameters.

Device 101 may optionally include side lips 123 to increase the security of lid member 105. Side lips 123 are similar in form and function to that of lower lip 119. Side lips 123 are configured to extend away from with walls 107b and 107c and have a backing material to form a channel. In operation, lid member 105 translates through side lip 123 prior to being seated adjacent lower lip 119. Side lips 123 secure edges 125 of lid member 103.

In regards to securing the upper surface of lid member 105, base member 103 includes a flange 127 configured to extend out from wall 107a. Flange 127 is configured to selectively pass through the lid member 105. Member 105 includes a slot 129 for acceptance of flange 127. Flange 127 may be attached to any wall on base member 103 and is not restricted to wall 107a. When seated, lid member 105 is secured by using a locking device 131 that couples to flange 127. Any typical locking device is possible. Locking device 131 is optionally included within device 101. Flange 127 may be either integrally formed into base member 103 or may be a detachable member that selectively detaches and couples to the members of device 101. Flange 127 may be configured to pass through any aperture or vent or slot. This detachable feature would allow a user to select a most convenient location for the locking device.

Lid member 105 also includes a locking device platform 133 formed onto the upper face of lid member 105. Platform 133 is adjacent to slot 129 and is configured to support locking device 131 in a proper orientation. The orientation is selected such that platform 133 provides a stable base for locking device 131 and helps to stabilize it and prevent undesired motion. Depending on the type of locking device used, the level of motion and stabilization required can increase. When the locking device includes an internal catch to pass through flange 127, the internal catch is concealed and is therefore very shielded by the body of the locking device so as to greatly deter any chance of cutting the internal latch to remove the locking device. These types of locking devices are preferred. Platform 133 provides support for such locking devices to ensure the locking device stays oriented in a level manner relative to the plane of the top face of lid member 105.

It is understood that device 101 is scalable to fit any size computer. The length, width, and depth of device 101 may be adjusted accordingly.

The current application has many advantages over the prior art including at least the following: (1) a fully enclosed vehicle computer locking device; (2) ability to fasten the computer to the vehicle with existing methods; (3) ports and vents for adequate airflow; and (4) cost savings from the prevention of theft.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A vehicle locking device for securing a computer within an engine compartment of the vehicle, comprising:
a base member configured to releasably couple to a wall of the engine compartment, the base member having a plurality of walls defining an internal volume for locating the computer; and
a lid member in selective communication with the base member, such that the lid member covers at least two sides of the base member;
wherein the lid member and the base member are configured to prevent the unauthorized access and removal of the computer from the engine compartment.

2. The device of claim 1, wherein the base member is configured so as to allow for the use of existing mounting fasteners of the computer.

3. The device of claim 1, wherein the base member includes vent apertures to permit airflow through the internal volume of the base member to regulate the temperature of the computer.

4. The device of claim 1, wherein the base member includes a lower lip for acceptance of the lid member, the lid member translating into the lip as the lid member is located in position relative to the base member.

5. The device of claim 1, wherein the base member includes at least one side lip for acceptance of the lid member, the lid member configured to translate through the at least one side lip as the lid member is located in position relative to the base member.

6. The device of claim 1, wherein the base member includes at least one side port for the passage of cables in communication with the computer.

7. The device of claim 1, wherein the base member includes a flange configured to extend out from an upper surface of the base member, the flange configured to selectively pass through the lid member.

8. The device of claim 7, wherein the flange is configured to engage a locking device after the lid member is positioned, such that the lid member is secured onto the base member.

9. The device of claim 1, wherein the lid member includes vent apertures to permit airflow through the internal volume of the base member to regulate the temperature of the computer.

10. The device of claim 1, wherein the lid member includes a locking device platform configured to support a locking device used to engage a flange in communication with the base member.

11. The device of claim 10, wherein the locking device platform is configured to elevate and provide a stable base for the locking device.

12. The device of claim 10, wherein the locking device platform is configured to stabilize the locking device to prevent undesired motion of the locking device.
